(19) United States
(12) Patent Application Publication
(10) Pub. No.: US 2026/0317192 A1
(43) Pub. Date: Oct. 15, 2026

(54) METHOD AND ARRANGEMENT FOR PRODUCING PCC

(71) Applicant: Wetend Technologies Oy, Savonlinna (FI)

(72) Inventor: Jouni MATULA, Savonlinna (FI)

(21) Appl. No.: 19/481,844

(22) PCT Filed: May 3, 2024
(86) PCT No.: PCT/FI2024/050212

§ 371 Date: Nov. 5, 2025

(30) Foreign Application Priority Data
May 8, 2023 (FI) 20235507

(51) Int. Cl. C01F 11/18

(52) U.S. Cl. CPC C01F 11/181; C01F 11/185

(57) ABSTRACT

A method and arrangement for producing precipitated calcium carbonate (PCC) from ground calcium carbonate (GCC). The method includes: a) an aqueous process fluid (1), carbon dioxide CO2 (3) and GCC (2) are mixed together and a pressure is set, b) the carbon dioxide dissolves, whereupon the pH falls, c) in the conditions, the GCC or a part of the GCC dissolves according to CaCO3 (s)+2 H+(aq)→Ca2+(aq)+CO2 (g)+H2O(l), d) pressure is reduced, e) the carbon dioxide is released as gas, whereupon the pH rises and Ca2+ and CO2 are crystallized as PCC, f) degassing is carried out, CO2 is led through the recycling line back to process step a), and g) the precipitated calcium carbonate (PCC) or its derivatives, such as PCC agglomerates, GCC+PCC clusters or the PCC/GCC mixture, are led forward.

### FIELD OF THE INVENTION

The present invention relates to a method and arrangement for producing calcium carbonate CaCO₃ crystals, that is, PCC, in a process fluid, or suspension, most preferably directly in the process fluid flow itself. More specifically, the invention relates to the method according to the preamble of claim 1.

The invention further relates to an arrangement according to the preamble of claim 15.

### TECHNICAL BACKGROUND

Calcium carbonate is commonly used in papermaking processes as both filler and coating material due to, among others, the high brightness and low cost of carbonate. Calcium carbonate can be produced by grinding from chalk, marble or limestone, which is then called ground calcium carbonate, or calcite, commonly referred to and abbreviated as GCC (Ground Calcium Carbonate). Another method of producing calcium carbonate is the chemical method, in which e.g. carbonate ions, formed when the calcium ions, the other constituent of calcium hydroxide, and carbon dioxide are dissolved in water, are allowed to react, whereby the formed calcium carbonate is precipitated from the solution as crystals the shape and size of which depends on e.g. the reaction conditions. The end product of this production method is called PCC, which is an abbreviation of the words Precipitated Calcium Carbonate (i.e. crystalline CaCO₃). The chemical composition of PCC and GCC is the same, but they differ in crystal form and purity. GCC is an irregular, fine, ground, crushed product, whereas PCC crystals have a uniform and regular shape. This invention concentrates on the production of PCC and on an arrangement for producing it in the process apparatus as an in-line process.

Traditionally, the production of PCC has taken place separate from the actual production process of the main product, e.g. paper manufacture. So far, PCC has been produced either at a dedicated plant located near the paper mill, from which the PCC slurry is directed by pumping along pipelines to paper production, or at a corresponding plant from which the PCC slurry is transported by tank trucks to paper mills located farther away. PCC produced by this method requires the use of retention materials in papermaking in order to have the PCC fastened to the fibers, regardless of whether the fibers are produced chemically or mechanically. The use of retention materials naturally causes additional costs to papermaking in the form of acquiring the chemical itself and as precipitation or recyclability problems possibly caused by the chemical. The traditional method of producing PCC briefly described above brings about problems in addition to the problems relating to the use of retention materials. Tank transportation of PCC to the paper mill from the production site causes transport costs and requires the use of dispersing agents and biocides. The use of the additives affects the properties of PCC while still increasing the acquiring and processing costs of the chemicals.

There have been numerous suggestions for producing PCC directly at the paper mill for reducing the production costs, whereby at least the transport costs of PCC are eliminated from the cost structure of paper. Additionally, in-line production of PCC in the presence of fiber suspension leads to better fastening of PCC crystals to the fibers, whereby the need for retention materials is at least reduced and in some cases their use can be totally eliminated. In this context, in-line production means producing PCC directly to a suspension used in the production of a fibrous web, fiber product or the like so that PCC or the suspension is not kept in intermediate storage but it is directly used in the production of the fibrous web, fiber product or the like. One industrially applicable in-line method for producing PCC is dis-cussed in the patent application WO-A2-2009/103854. This disclosure teaches production of PCC from carbon dioxide and lime milk so that the carbon dioxide and lime milk are mixed very effectively, preferably by using injection mixers, directly into the pulp in the flow pipe transporting the pulp to the headbox of the paper machine. Thereby, due to the efficient mixing, the carbonate ions and the calcium ions are located close to each other and the formation of crystals is very fast.

There are also numerous other uses for PCC, where the ease of PCC production in connection with the actual product process, minimization of the amount of extra additives and the simplicity of the method would be an ad-vantage.

### DESCRIPTION OF THE INVENTION

The aim of the invention is to provide a method that works efficiently and economically as well as reliably to produce PCC in different processes. An aim of the invention is also to provide an arrangement by means of which the said method can be implemented. The aims of the invention are mainly achieved as disclosed in greater detail in independent claims 1 and 15 as well as in the other claims.

An additional aim of the invention is to provide a method by means of which precipitated calcium carbonate (PCC) can be produced simply and efficiently from ground calcium carbonate (GCC). The method generally comprises the following steps:
a) an aqueous process fluid (1), carbon dioxide CO₂ (3) and GCC (2) are mixed together and the pressure is set,
b) the carbon dioxide dissolves, whereupon the pH falls,
c) the GCC or a part of the GCC dissolves:

CaCO₃ (s)+2 H⁺(aq)→Ca²⁺(aq)+CO₂ (g)+H₂O(l),
d) pressure is reduced,
e) the carbon dioxide is released as gas, whereupon the pH rises and Ca²⁺ and CO₂ are crystallized as PCC,
f) degassing is carried out, CO₂ is led through the recycling line back to process step a) and/or for other use,
g) the process fluid and the precipitated calcium carbonate (PCC) or its derivatives, such as PCC agglomerates, fiber+PCC composites, GCC+PCC clusters or the PCC/GCC mixture, are led forward.

The method for producing precipitated calcium carbonate (PCC) from ground calcium carbonate (GCC) can generally be implemented under the following indicative conditions, which are partly dependent on each other and especially on the values at the starting point:
a) an aqueous process fluid at a temperature in the range of 5-50 °C and with a pH in the range of 6-9, carbon dioxide CO₂ and GCC are mixed together and the pressure is set at the level of 3-15, preferably at approximately 10 bar,
b) the carbon dioxide dissolves, whereupon the pH falls to a value of 3-4 or 5-6.5, depending on the order of mixing,
c) in the said conditions, all of the GCC or a part of the GCC dissolves:

CaCO₃ (s)+2 H⁺(aq)→Ca²⁺(aq)+CO₂ (g)+H₂O(l),
d) pressure is reduced, whereupon the pressure of the mixture is lowered to the range of atmospheric pressure (atm) −5 bar,
e) the carbon dioxide is released as gas, whereupon the pH rises to the range of 6-8 and Ca²⁺ and CO₂ are crystallized as PCC,
f) degassing is carried out, the pressure is reduced depending on step d) to a sufficiently low level, whereupon the carbon dioxide released as bubbles is removed from the process fluid and led through the recycling line back to process step a) and/or for other use,
g) the process fluid and the precipitated calcium carbonate (PCC) or its derivatives, such as PCC agglomerates, fiber+PCC composites, GCC+PCC clusters or the PCC/GCC mixture, are led forward.

Thus, a basic idea of the method is that substances in suitable conditions are mixed together into a solution, the pH falls particularly due to the effect of the dissolved carbon dioxide, whereupon the GCC also dissolves. Carbon dioxide cannot remain dissolved unless the pressure is sufficiently high, whereupon by reducing pressure, the carbon dioxide can be released, which causes the pH to rise, whereupon the dissolved GCC is in turn precipitated as PCC. After degassing, the PCC can be used for the desired purpose and the carbon dioxide can be recycled back into the process. In this way, an almost closed cycle can be achieved regarding the carbon dioxide balance in the method; only the carbon dioxide discharged with the PCC and the process fluid must be genuinely added to the process. On the other hand, since the carbon dioxide can be recycled back into the process, it is not necessary to recycle the same carbon dioxide into this particular process. The carbon dioxide released or a part of it can be diverted to other use or used elsewhere.

Method step a) describes in general terms the mixing of the aqueous process fluid, carbon dioxide and GCC, but the order in which they are mixed has a significant effect on the course of the process. Carbon dioxide can be mixed in the method as a fluid or gas, when it is taken into account that carbon dioxide exists in liquid form only under pressure (over 5.2 bar, temperature −56.6+−30.6 °C). Under atmospheric pressure, carbon dioxide does not exist in liquid form. Similarly, GCC can be introduced into the method as an aqueous slurry, which is probably the easiest method of implementation in terms of mixing technique, but possibly also as an aerosol with air or carbon dioxide acting as a carrier gas. The different mixing order alternatives are described in greater detail in the following.

Alternative 1): step a) is carried out in the following order:
the pressure of the process fluid is set at a level of 3-15 bar,
carbon dioxide is mixed into the process fluid, whereupon the pH falls to a level of <5, such as 3-4,
GCC is mixed into the process fluid.

In this case, when the carbon dioxide is mixed into the process water, the pH will fall relatively easily to a level of 3-4. After this, the GCC dissolves well and quickly in the said fluid.

Alternative 2): step a) is carried out in the following order:
GCC is mixed into the process fluid,
the pressure of the process fluid is set at a level of 3-15 bar,
carbon dioxide is fed/dissolves in the process fluid, whereupon the pH falls to a level of <5-6.5.

In this alternative, when the GCC is mixed in the process fluid before the carbon dioxide, the GCC brings about a buffer effect, that is, forms a buffer solution with water, the pH value of which does not change significantly when acid (or alkali) is added or the solution is diluted. Therefore, after the addition of carbon dioxide, the pH remains approximately at <6.5, whereas with the order according to the previous alternative 1) it fell to a level of 3-4. The GCC is preferably fed into the process fluid at such pressure and with such means that the GCC mixes evenly in the process fluid. In this way, the reaction gives the best yield.

Alternative 3): step a) is carried out in the following order:
the pressure is set at a level of 3-15 bar,
carbon dioxide and the GCC slurry are mixed,
the carbon dioxide dissolves, whereupon the pH falls to a level of <6.5, whereupon the GCC dissolves,
the dissolved GCC is mixed into a process fluid which is at an approximately 3-5 bar lower pressure.

Also in this alternative, the GCC slurry acts as a buffer solution affecting the change in pH.

Alternative 4): step a) is carried out in the following order:
the pressure is set at a level of 3-5 bar,
carbon dioxide and pure water are mixed,
the carbon dioxide dissolves, whereupon the pH falls to a level of 3-4,
GCC is added, whereupon the GCC dissolves,
the mixture is mixed into a process fluid which is at an approximately 3-5 bar lower pressure.

In this alternative, the first reduction of pressure in the method, that is, step d), can be carried out already as the last point under step a) when the dissolved GCC is mixed into the process fluid. A sufficient pressure difference of the GCC when mixing into the process fluid is of the order of 3 bar, which results in a high degree of mixing and the reduction in pressure becomes such that the carbon dioxide begins to release as gas. Furthermore, in this alternative, pure water refers to water with a pH of 7±2 and/or which does not contain a significant amount of the substance that makes up the process fluid suspension or other substance that reacts with carbon dioxide.

According to one embodiment, in the method, carbon dioxide CO₂ is fed in an amount which dissolves, in each of the said conditions, in the fluid to be mixed undersaturated/saturated. The aim of this feature is to achieve an adequate fall in pH for the dissolution of GCC with a reasonable amount of carbon dioxide. The amount of carbon dioxide that dissolves at any given time depends on the temperature and pressure.

According to one embodiment, in steps d)-f) of the method, pressure is reduced in two or more stages to separate the dissolved carbon dioxide from the process fluid. One factor affecting the separation is that during step d), the process fluid becomes supersaturated with carbon dioxide in the said conditions.

According to some embodiments of alternatives 2) or 3), more carbon dioxide is fed into the process fluid after the pressure reduction under step d). The purpose of this step is to ensure that the pH is sufficiently low in all respects.

One embodiment of the invention is an arrangement for producing precipitated calcium carbonate (PCC) from ground calcium carbonate (GCC). The arrangement comprises the following means:
an apparatus for mixing together an aqueous process fluid, carbon dioxide CO₂ and GCC and for setting the pressure at a level of approximately 3-15 bar,
a reactor for dissolving the GCC or a part of the GCC:

CaCO₃ (s)+2 H⁺(aq)→Ca²⁺(aq)+CO₂ (g)+H₂O(l),
a device, such as a choke, valve or the like, for reducing the pressure to a range of 2-5 bar,
a reactor for releasing carbon dioxide as gas and for crystallizing Ca²⁺ and CO₂ as PCC,
a gas separator, where the pressure of the process fluid can be further reduced, whereupon the carbon dioxide released as bubbles can be separated from the process fluid and led through the recycling line back to the beginning of the process and/or for other use,
a pipe for leading the process fluid and the precipitated calcium carbonate produced (PCC) or its derivatives, such as PCC agglomerates, fiber+PCC composites, GCC+PCC clusters or the PCC/GCC mixture, forward.

The apparatus for mixing the aqueous process fluid, carbon dioxide and GCC together and for setting the pressure at the specified level may in practice be, for example, the applicant's TrumpJet® mixer connected to the process pipeline or other similar apparatus intended for mixing fluids or gases. For setting the pressure at the desired level can be used pumps, flow resistors or the like, or containers into which the substances to be mixed are fed.

In connection with this invention, the reactor refers to a space within which the reaction is to take place. It may be, for example, a pipe, container or tank, always depending on the case. One characteristic of the reactor is the retention time; the substance being processed must remain in the reactor for as long as necessary for each reaction.

According to one embodiment of the invention, a gas separator is arranged, wherein the pressure of the process fluid can be further reduced, whereupon the carbon dioxide released as bubbles can be separated from the process fluid and led through the recycling line back to the beginning of the process. In this case, the process fluid is degassed in step f) of the method, whereupon the carbon dioxide released as bubbles is removed by means of a centrifuge, vacuum tank or similar gas separator, or other gas separation device from the process fluid and led through the recycling line back to method step a). The gas separator may reduce the pressure of the fluid processed to the level of atmospheric pressure (atm), or even to underpressure, with the aim of making the carbon dioxide form bubbles which can be separated from the fluid. However, the gas separator is preferably selected so that the separation method used therein does not cause significant breakage of the previously formed PCC crystals.

According to one embodiment of the invention, the arrangement is implemented as an in-line reactor in a process using PCC, such as in a process using pulp fiber, a paint industry process or pharmaceutical industry process. Other additional features characteristic of the invention appear from the accompanying claims and the following description of the embodiments in the figures.

### LIST OF DRAWINGS

The invention and its operation are described in the following, with reference to the accompanying diagrammatic drawings, in which

FIG. 1 shows the solubility of carbon dioxide at different pressures and temperatures

FIG. 2 shows diagrammatically an embodiment of the method according to the invention,

FIG. 3 shows diagrammatically an embodiment of the method according to the invention,

FIG. 4 shows diagrammatically an embodiment of the method according to the invention,

FIG. 5 shows diagrammatically an embodiment of the method according to the invention.

### DESCRIPTION OF THE DRAWINGS

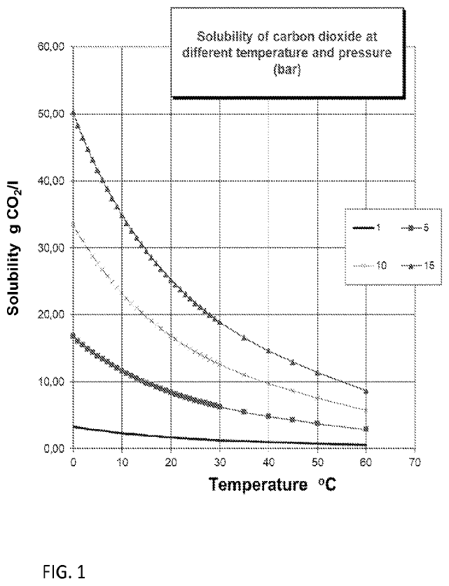

In FIG. 1B can be observed that the solubility of carbon dioxide is the greater the closer the solution is to the temperature of 0 °C. In addition to the temperature, the pressure levels 1, 5, 10 and 15 bar shown in FIG. 1B have a significant effect on the solubility of carbon dioxide. On the basis of the factors affecting the solubility of these two substances and other factors affecting the management of the production process, a process fluid at the temperature range of 5-50 °C is estimated to be best suited to the method now in question because the required sufficient solubility of carbon dioxide is easier to ensure by means of pressure.

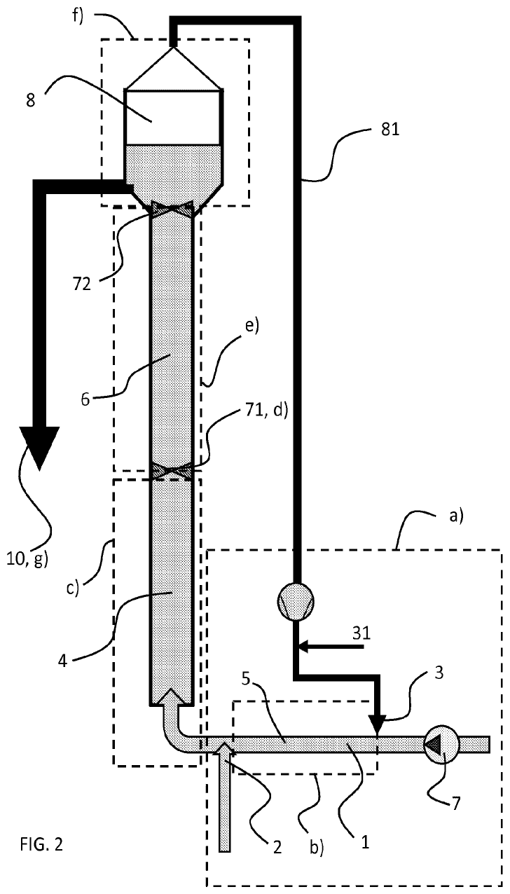

FIG. 2 shows an embodiment of the arrangement according to the invention for producing precipitated calcium carbonate (PCC) from ground calcium carbonate (GCC). The arrangement comprises the following means:
an apparatus 2, 3, 7 for mixing together an aqueous process fluid 1, carbon dioxide CO₂ 3 and GCC 2 and for setting the pressure 7 at a level of approximately 3-15 bar, preferably 10 bar,
a reactor 4 for dissolving the GCC or a part of the GCC:

CaCO₃ (s)+2 H⁺(aq)→Ca²⁺(aq)+CO₂ (g)+H₂O(l),
a device 71 such as a choke, valve or the like for reducing the pressure to the range of 2-5 bar,
a reactor 6 for releasing carbon dioxide as gas and for crystallizing and Ca²⁺ and CO₂ as PCC,
a gas separator 8, where the pressure of the process fluid 1 can be further reduced, where the gas separator 8 may comprise a pressure reducer 72, whereupon the carbon dioxide released as bubbles can be separated from the process fluid and led through the recycling line 81 back to the beginning of the process, if necessary, new carbon dioxide being supplied to the recycling line 81 through an additional carbon dioxide feed 31,
a pipe 10 for leading the process fluid and precipitated calcium carbonate (PCC) produced or its derivatives, such as PCC agglomerates, fiber+PCC composites, GCC+PCC clusters or the PCC/GCC mixture, forward. To illustrate the method steps, in FIG. 2 and the other figures, the locations of method steps a), b), c), d), e), f) and g) in the diagrammatic process are shown as broken-line boxes or sections.

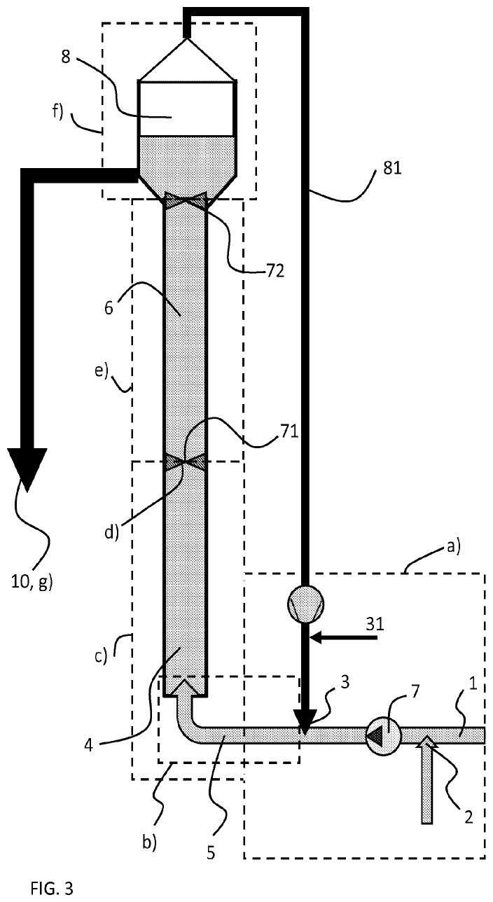

FIG. 2, as well as FIGS. 3, 4 and 5 show how the method is implemented in the different embodiments. According to the invention, precipitated calcium carbonate (PCC) is produced from ground calcium carbonate (GCC). The method comprises the following steps:
a) an aqueous process fluid at a temperature in the range of 5-50 °C and with a pH in the range of 6-9, preferably 6.7-8.2, carbon dioxide CO₂ and GCC are mixed together and the pressure is set at a level of 3-15 bar, preferably approximately 10 bar,
b) carbon dioxide dissolves, whereupon the pH falls to a value of 3-4 or 5-6.5, depending on the order of mixing,
c) in the said conditions, the GCC or a part of the GCC dissolves:

CaCO₃ (s)+2 H⁺(aq)→Ca²⁺(aq)+CO₂ (g)+H₂O(l),
d) pressure is reduced, whereupon the pressure of the mixture is reduced to the range of atmospheric pressure (atm) −5 bar,
e) the carbon dioxide is released as gas, whereupon the pH rises to the range of 6-8 and Ca²⁺ and CO₂ are crystallized as PCC,
f) degassing is carried out, the pressure is reduced depending on step d) to a sufficiently low level, whereupon the carbon dioxide released as bubbles is removed from the process fluid and led through the recycling line 81 back to process step a),
g) the process fluid and the precipitated calcium carbonate (PCC) produced or its derivatives, such as PCC agglomerates, fiber+PCC composites, GCC+PCC clusters or the PCC/GCC mixture, are led forward.

FIG. 2 shows an embodiment where step a) is carried out in the following order:
the pressure of the process fluid 1 is set at a level of 3-15 bar (by means of a pump 7),
carbon dioxide is fed into (mixer 3)/dissolves (reactor 5) in the process fluid, whereupon the pH falls to a level <5, such as 3-4,
GCC is mixed in the process fluid (mixer 2).

FIG. 3 shows an embodiment where step a) is carried out in the following order:
GCC is mixed in the process fluid 1 (mixer 2)
the pressure of the process fluid 1 is set at a level of 3-15 bar (pump 7),
carbon dioxide is fed into (mixer 3)/dissolves in the process fluid 1 during step c), whereupon the pH falls to a level of <5-6.5.

After this, the method corresponds to what was disclosed in connection with FIG. 2.

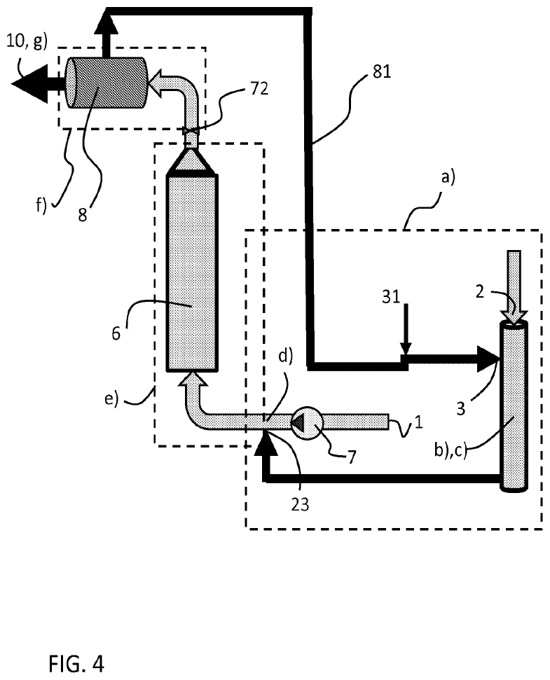

FIG. 4 shows an embodiment where step a) is carried out in the following order:
pressure is set at a level of 3-15 bar,
carbon dioxide 3 and the GCC slurry 2 are mixed,
the carbon dioxide dissolves, whereupon the pH falls to a level of <6.5, whereupon the GCC dissolves,
the dissolved GCC/CO₂ mixture 23 is mixed into a process fluid 1 which is at an approximately 3-5 bar lower pressure, which causes/brings about method step d).

After this, the process continues as in the previous embodiments, PCC crystallizes in the reactor 6, carbon dioxide is released, and the remaining degassing is completed by means of the pressure reducer 72 and the gas separator 8 before leading the end product forward along the pipe 10.

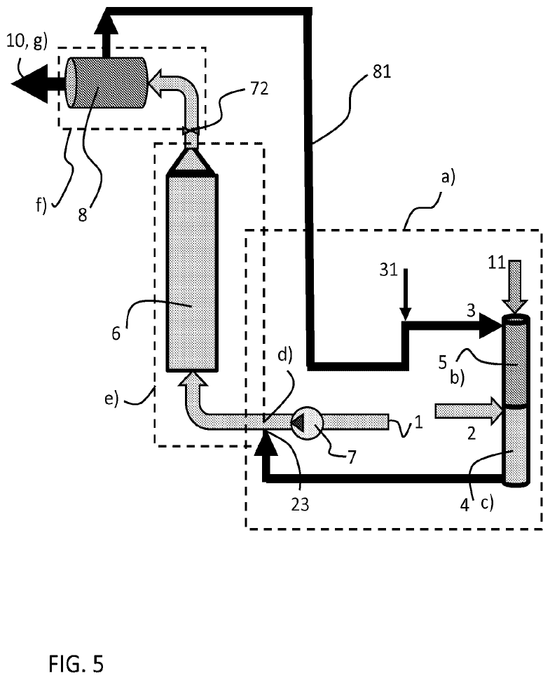

FIG. 5 shows an embodiment where step a) is carried out in the following order:
pressure is set at a level of 3-15 bar,
carbon dioxide 3 and pure water 11 are mixed,
carbon dioxide dissolves, whereupon the pH falls to a level of 3-4,
GCC 2 is added, whereupon the GCC dissolves,
the dissolved GCC 23 is mixed with the process fluid 1 which is at an approximately 3-5 bar lower pressure.

It should be noted that only a few of the most advantageous embodiments of the invention are disclosed above. It is, therefore, obvious that the invention is not limited to the foregoing embodiments but can be applied in many ways within the scope defined by the accompanying claims. The features presented in connection with the different embodiments may also be used in connection with other embodiments within the basic idea of the invention and/or the features presented may be combined into various entities if so desired and if the technical possibilities for doing so exist.

### LIST OF REFERENCE NUMERALS USED

1 Process fluid pipe/aqueous process fluid
11 Pure water
2 GCC feed (mixer)
3 Carbon dioxide feed (mixer)
31 Additional carbon dioxide feed
23 GCC/CO₂ mixture
4 Reactor (for dissolving GCC)
5 Reactor (for dissolving carbon dioxide)
6 PCC reactor
7 Pressure adjuster (pump)
71 Pressure reducer
72 Pressure reducer
8 Gas separator
81 Carbon dioxide recycling
10 Pipe

1. A method for producing precipitated calcium carbonate (PCC) or derivatives of PCC from ground calcium carbonate (GCC), wherein the method is carried out as an in-line process directly in an aqueous process fluid flow to produce in the aqueous process fluid flow the PCC or the derivatives of the PCC and the aqueous fluid flow with the PCC or the derivatives of the PCC is used to form a fibrous web or a fiber product, wherein the method comprises:
a) mixing into the aqueous process fluid flow carbon dioxide (CO₂) and GCC, while the aqueous process fluid flow is at a temperature in a range of 5 °C to 50 °C, at a pH in range of 5 to 9, and under a pressure in a range of 3 bar to 15 bar,
b) dissolving the carbon dioxide into the aqueous process liquid with the dissolved carbon dioxide, whereupon the pH of the aqueous process liquid in the flow falls to a range of 3 pH to 6.5 pH due to the dissolved carbon dioxide,
c) dissolving at least some of the GCC mixed into the aqueous process fluid which results in the following reaction:
CaCO₃ (s)+2 H⁺(aq)→Ca²⁺(aq)+CO₂ (g)+H₂O(l),
d) reducing the pressure on the mixture of the GCC, the carbon dioxide and the aqueous liquid after the reaction,
e) releasing carbon dioxide gas from the mixture of the GCC, the carbon dioxide and the aqueous process liquid due to the reduction in the pressure, whereupon the pH of the mixture of the GCC, the carbon dioxide and the aqueous process liquid rises to a range of 6 pH to 8 pH and the and Ca²⁺ (aq) and CO₂ produced by the reaction crystallizes into PCC or derivatives of PCC,
f) the releasing of the carbon dioxide gas includes the carbon dioxide being released as carbon dioxide bubbles which are removed from the mixture, and
g) the PCC or the derivatives of the PCC flow with aqueous fluid flow to generate the fibrous web or the fiber product.

2. The method according to claim 1, wherein the step a) is carried out in the following order:
the pressure of the aqueous process fluid is set in a range of 3 bar to 15 bar,
the carbon dioxide is mixed into the aqueous process fluid, whereupon the pH of the mixture of the carbon dioxide and the aqueous process fluid falls to a level of less than 5 pH, and
the GCC is mixed into the mixture of the aqueous process fluid and the carbon dioxide.

3. The method according to claim 1, wherein the step a) is carried out in the following order:
the GCC is mixed into the aqueous process fluid,
the pressure of the process fluid is set in a range of 3 bar to 15 bar, and
the carbon dioxide is dissolved into the process fluid, whereupon the pH of the aqueous process fluid with dissolved carbon dioxide falls to less than 6.5 pH.

4. The method according to claim 1, wherein the step a) is carried out in the following order:
the pressure of the aqueous process fluid is set to a range of 3 bar to 15 bar,
the carbon dioxide and the GCC -are mixed into the aqueous process fluid in parallel or in sequence,
as the carbon dioxide dissolves in the aqueous process fluid, the pH of the aqueous process fluid with the dissolved carbon dioxide falls below pH 6.5, and
the pressure of the aqueous process fluid with the dissolved carbon dioxide is lowered to a range of 3 bar to 5 bar to promote the dissolving of the GCC in the aqueous process fluid with the dissolved carbon dioxide.

5. The method according to claim 1, wherein the step a) is carried out in the following order:
the aqueous process fluid is initially pure water, and the pressure of the pure water is in a range of 3 bar to 15 bar,
the carbon dioxide and the pure water are mixed,
as the carbon dioxide dissolves in the pure water the pH of the pure water with the dissolved carbon dioxide falls to a range of 3 pH to 4 pH,
the GCC is mixed and dissolved into the pure water with the dissolved carbon dioxide, and
the pressure is reduced on the pure water with the dissolved carbon dioxide and the dissolved GCC.

6. The method according to claim 1, wherein during the step a) the carbon dioxide is fed in an amount such that the dissolved carbon dioxide is in an undersaturated or saturated condition.

7. The method according to claim 1, wherein in steps d) to f), the pressure is reduced in two or more stages to separate the dissolved carbon dioxide from the mixture.

8. The method according to claim 1, wherein in the step f), the dissolved carbon dioxide is degassed from the aqueous process fluid, whereupon the carbon dioxide is released as bubbles and removed by a centrifuge, vacuum tank, gas separator, or other gas separation device from the aqueous process fluid and fed to recycling line back to the step a).

9. The method according to claim 3, wherein the GCC mixed evenly in the aqueous process fluid.

10. The method according to claim 5, wherein the pure water has a pH in a range of 5 to 9 and does not contain a significant amount of the substance that that reacts with carbon dioxide.

11. The method according to claim 2, further comprising feeding additional carbon dioxide into the aqueous process fluid after the pressure reduction in the step d).

12. The method according to claim 1, wherein during the step d) the aqueous process fluid becomes supersaturated with carbon dioxide.

13. The method according to claim 1, wherein the temperature of the process fluid is in a range of 5 °C to 50 °C.

14. An arrangement for producing precipitated calcium carbonate (PCC) or derivatives of PCC, from ground calcium carbonate (GCC), wherein the arrangement is configured to produce PCC directly to in an aqueous process fluid flowing in an in-line process to produce a fibrous web, a fiber product or other fiber product, the arrangement comprising:
an a mixer through which flows the aqueous process fluid, wherein the mixer is configured to receive and mix carbon dioxide and GCC with the aqueous process fluid and the mixer maintains the aqueous process fluid at a pressure in a range of 3 bar to 15 bar while mixing the carbon dioxide and the GCC in the aqueous process fluid;
a reactor configured to react the GCC that has been mixed in the aqueous process fluid in a rection represented as:
CaCO₃ (s)+2 H⁺(aq)→Ca²⁺(aq)+CO₂ (g)+H₂O(l),
a pressure reduction device configured to reduce the pressure in the reactor to a pressure in a range of 2 bar to 5 bar,
wherein the reactor is configured to reduce the pressure of the aqueous process fluid to cause the CO₂ (g) from the reaction to form carbon dioxide bubbles and to allow the Ca²⁺ and CO₂ to crystallize as PCC,
a gas separator coupled to the reactor and configured to receive as a carbon dioxide gas the carbon dioxide bubbles and the carbon dioxide gas is separated from the aqueous process fluid, and
a pipe coupled to the reactor and conveying the aqueous process fluid with the crystallized PCC or derivatives of the crystallized PCC in the in-line process to produce the fibrous web, the fiber product or the other fiber product.

15. The arrangement according to claim 14, wherein the arrangement is implemented as an in-line reactor in a process using the crystallized PCC or the derivative of the crystallized PCC in a pulp fiber process, in a paint industry process or in a pharmaceutical industry process.

16. A method for precipitating calcium carbonate (PCC) or derivatives of PCC from ground calcium carbonate CaCO₃ (GCC) in an aqueous process fluid flowing in an in-line process to generate a fibrous web or other fiber product, wherein the method comprises:
while the flow of the aqueous process fluid is in a temperature range of 5 °C to 50 °C, at a pressure of 3 bar to 15 bar and at a pH in range of 5 to 9, mixing carbon dioxide (CO₂) into the aqueous process fluid;
reducing the pH of the aqueous process fluid to a range of 3 pH to 6.5 pH by the dissolving of the carbon dioxide in the aqueous process fluid, mixing GCC into the aqueous process fluid;
reacting the aqueous process fluid, the carbon dioxide and the GCC according to:
CaCO₃ (s)+2 H⁺(aq)→Ca²⁺(aq)+CO₂ (g)+H₂O(l),
reducing the pressure of the aqueous process fluid with the carbon dioxide and the GCC;
due to the reduction in the pressure, releasing carbon dioxide gas from the aqueous process fluid with the carbon dioxide and the GCC and separating the carbon dioxide gas from the aqueous process fluid,
reducing the pH of the aqueous process liquid with the Ca²⁺ (aq) and CO₂ to a range of 6 pH to 8 pH to crystallize the Ca2+ (aq) into PCC or derivatives of PCC formed in the aqueous process fluid, and
using the PCC or the derivatives of the PCC in the aqueous process fluid in the in-line process to generate the fibrous web or the fiber product.

17. The method according to claim 16, wherein the carbon dioxide is dissolved into the aqueous process fluid while the pH of is less than 5 pH, and
the GCC is mixed into the aqueous process fluid after the carbon dioxide is mixed into the aqueous process fluid.

18. The method according to claim 16, wherein the GCC is mixed into the aqueous process fluid while the pressure of the aqueous process fluid is in a range of 3 bar to 15 bar, and before the carbon dioxide is dissolved into the process fluid.

19. The method according to claim 16, wherein while the aqueous process fluid is pure water before being mixed with the carbon dioxide and the GCC.

20. The method according to claim 16, further comprising feeding the released carbon dioxide gas to the aqueous process fluid as at least a portion of the carbon dioxide mixed and dissolved into the aqueous process fluid.
